(19) United States
(12) Patent Application Publication
(10) Pub. No.: US 2026/0127517 A1
(43) Pub. Date: May 7, 2026

(54) TRAINING OPERATORS BASED ON HISTORICAL DATA AND USER CONTEXT

(71) Applicant: INTERNATIONAL BUSINESS MACHINES CORPORATION, ARMONK, NY (US)

(72) Inventors: Carl Albert Petersson, Georgetown, TX (US); Francisco Javier Rodriguez, Austin, TX (US); Hidematsu Atom Sueki, Morrisville, NC (US); Jacob Michael Zielny, Raleigh, NC (US)

(21) Appl. No.: 18/940,766

(22) Filed: Nov. 7, 2024

(51) Int. Cl. G06Q 10/0631

(52) U.S. Cl. CPC G06Q 10/063112

(57) ABSTRACT

Managing operator requests through intercepting, in a data processing environment, an incoming operator request from an operator, retrieving historical data related to commands and command outcomes of the operator in the data processing environment, determine a skill level of the operator based on analysis of the retrieved historical data, and predicting a potential impact of the incoming operator request on the data processing environment based on an understanding of a mode of operation of the data processing environment. By blocking or allowing execution of the incoming operator request based on information about the skill level of the operator and the potential impact, the data processing environment can be secured against actions that can degrade the functioning on the environment. A skill of the operator is updated based on an outcome of the incoming operator request.

### BACKGROUND

### Technical Field

The present disclosure generally relates to enhancing operator efficiency in IT (information technology) environments through real-time feedback and training and more particularly, to a leveraging historical data and user context to assess operator actions, blocks potentially harmful commands, and provide adaptive learning opportunities in hybrid cloud settings.

### Description of the Related Art

Intelligent systems for workforce development and management focus on leveraging different technologies to optimize the processes of hiring, training, and managing employees. In the IT space, developers may go through structured onboarding processes to introduce them to coding standards, software architecture, and development workflows. This may help in understanding the intricacies of the codebase and processes in place to maintain code quality. Further, code reviews may be used when a developer writes new code or modifies existing code, wherein the code may be typically reviewed by peers or managers before being merged into the main codebase. This process helps catch potential issues that might disrupt existing functionality and ensures adherence to best coding practices.

### BRIEF SUMMARY

According to an illustrative embodiment, a method discloses managing operator requests through intercepting, in a data processing environment, an incoming operator request from an operator, retrieving historical data related to commands and command outcomes of the operator in the data processing environment, and generating information about a skill level of the operator based on analysis of the retrieved historical data. The method includes predicting a potential impact of the incoming operator request on the data processing environment based on an understanding of a mode of operation of the data processing environment. By blocking or allowing the incoming operator request based on information about the potential impact and a skill level of the operator, the data processing environment can be protected against actions that can degrade the functioning on the environment. A skill of the operator is updated based on an outcome of the incoming operator request.

In one embodiment, upon blocking the incoming operator request in real time, real-time feedback about alternative operator requests that meet a positive impact criterion is provided to the operator.

In one embodiment, the data processing environment is a Kubernetes-based cloud environment.

According to an embodiment of the present disclosure, a computing device includes a processor and a memory with computer program instructions that, when executed, enable the device to intercept, in a data processing environment, an incoming operator request from an operator, retrieve historical data related to commands and command outcomes of the operator in the data processing environment, and generate information about a skill level of the operator based on contextual analysis of the retrieved historical data. The program instructions further cause the computing device to predict a potential impact of the incoming operator request on the data processing environment based on an understanding of a mode of operation of the data processing environment. The program instructions further cause the computing device to block the incoming operator request based on information about the skill level of the operator and the potential impact and update the skill level value of the operator based on an outcome of the incoming operator request.

According to an embodiment of the present disclosure, a computer program product includes a computer-readable storage device and program instructions executable by a processor, comprising program instructions to to intercept, in a data processing environment, an incoming operator request from an operator, retrieve historical data related to commands and command outcomes of the operator in the data processing environment, and generate information about a skill level of the operator based on contextual analysis of the retrieved historical data. The program instructions further include program instructions to cause the computing device to predict a potential impact of the incoming operator request on the data processing environment based on an understanding of a mode of operation of the data processing environment. The program instructions further include program instructions to cause the computing device to block the incoming operator request based on information about the skill level of the operator and the potential impact and update the skill of the operator based on an outcome of the incoming operator request.

### BRIEF DESCRIPTION OF THE DRAWINGS

To easily identify the discussion of any particular element or act, the most significant digit or digits in a reference number refer to the figure number in which that element is first introduced.

FIG. 1 depicts a block diagram of a network of data processing systems in accordance with an illustrative embodiment.

FIG. 2 depicts a block diagram of a computing environment in accordance with an illustrative embodiment.

FIG. 3 depicts a block diagram of a request management engine in accordance with an illustrative embodiment.

FIG. 4 depicts a system diagram of a request management engine in accordance with an illustrative embodiment.

FIG. 5 depicts a flowchart of a routine in accordance with an illustrative embodiment.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high-level, without detail, in order to avoid unnecessarily obscuring aspects of the present teachings.

Human operators in IT environments may rotate very frequently, due to for example, attrition or individuals moving on to new roles. This turnover often results in a loss of accumulated expertise and knowledge, as the systems and environments typically outlast the tenure of the operators. When new operators are hired, they may be trained to ensure they can effectively manage and interact with these complex systems. Some of the training methods may often rely on static simulations or manual feedback, often failing to address the dynamic and evolving nature of real-time IT environments.

It is recognized that providing immediate feedback or guidance may be helpful in preventing potentially harmful actions by less experienced operators. The illustrative embodiments train operators of an IT environment based on historical knowledge of the IT environment (hereinafter referred to as a data processing environment) to provide real time feedback of the impact of operator requests on the data processing environment. The illustrative embodiments continuously update an understanding of the data processing environment as the environment evolves and evaluate a skill level of the operator to more accurately assess the impact of allowing operator requests to be executed.

The illustrative embodiments disclose the managing of operator requests to guide and train operators by authorized intercepting, in the data processing environment, an incoming operator request, retrieving previously stored operator specific historical data related to commands and outcomes in the data processing environment, and characterize a skill level of the operator based on analysis of the historical data. The illustrative embodiments predict a potential impact of the incoming operator request on the data processing environment based on a generated understanding of the operation of the data processing environment and block the incoming operator request based on information about the skill level of the operator and the potential impact, thereby preventing the malfunctioning, misuse, and ultimate collapse of the data processing environment.

Certain operations are described as occurring at a certain component or location in an embodiment. Such locality of operations is not intended to be limiting on the illustrative embodiments. Any operation described herein as occurring at or performed by a particular component, can be implemented in such a manner that one component-specific function causes an operation to occur or be performed at another component, e.g., at a local or remote engine respectively. In one aspect, the method described herein, is implemented to execute on a particularly configured computing device or data processing system and provides substantial advancement of the functionality of that computing device or data processing system by enabling the use dynamic management of operator requests to control the integrity and health of a data processing environment. Embodiments thus have the capacity to improve the technical field of IT and hybrid cloud environments by managing the stability of the environments while accommodating the continuous learning and skill development of new operators.

The illustrative embodiments are described with respect to certain types of data, functions, algorithms, equations, model configurations, locations of embodiments, additional data, devices, data processing systems, environments, components, and applications only as examples. Any specific manifestations of these and other similar artifacts are not intended to be limiting to the disclosure. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the disclosure, either locally at a data processing system or over a data network, within the scope of the disclosure. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the disclosure within the scope of the disclosure. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

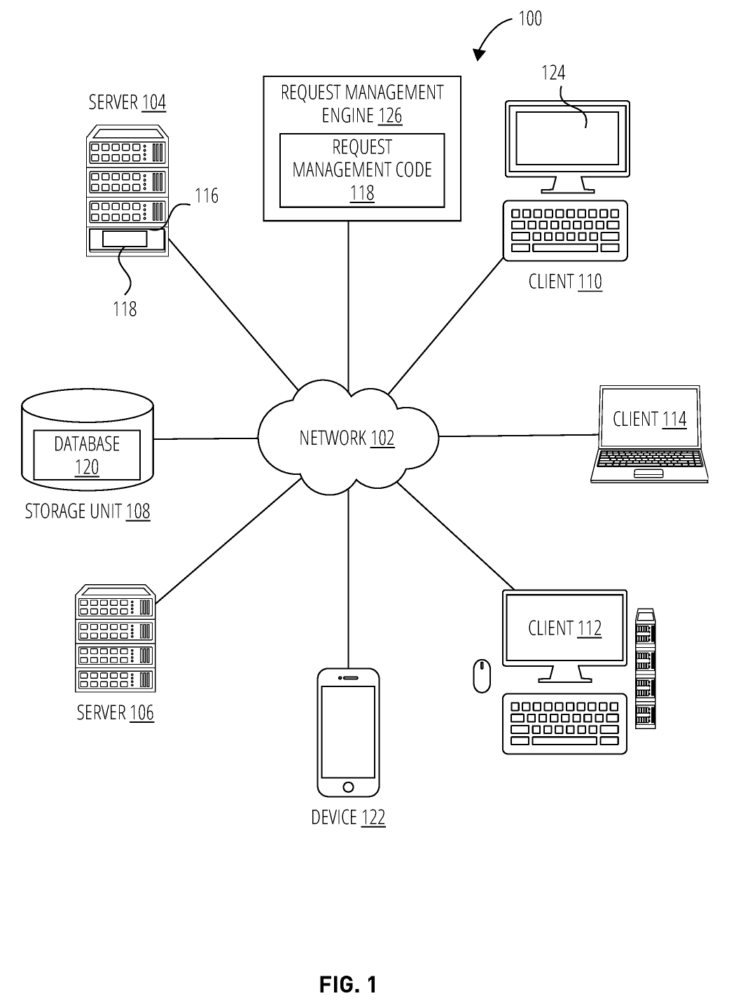

With reference to the figures and in particular with reference to FIG. 1 these figures are example diagrams of data processing environments in which illustrative embodiments may be implemented. FIG. 1 is only an example and is not intended to assert or imply any limitation with regard to the environments in which different embodiments may be implemented. A particular implementation may make many modifications to the depicted environments based on the following description.

With reference to the figures and in particular with reference to FIG. 1 these figures are example diagrams of data processing environments in which illustrative embodiments may be implemented. FIG. 1 is only an example and is not intended to assert or imply any limitation with regard to the environments in which different embodiments may be implemented. A particular implementation may make many modifications to the depicted environments based on the following description.

### Example Data Processing Environment

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Client 110, client 112, client 114 are also coupled to network 102. A data processing system, such as clients (client 110, client 112, client 114, engine) may include data and may have software applications or software tools executing thereon. Server 104 and server 106 may include one or more GPUs (graphics processing units) for machine learning.

Only as an example, and without implying any limitation to such architecture, FIG. 1 depicts certain components that are usable in an example implementation of an embodiment. For example, servers and clients are only examples and not to imply a limitation to a client-server architecture. As another example, an embodiment can be distributed across several data processing systems and a data network as shown, whereas another embodiment can be implemented on a single data processing system within the scope of the illustrative embodiments. Data processing systems (request management engine 126, server 104, server 106, client 110, client 112, client 114) also represent example nodes in a cluster, partitions, and other configurations suitable for implementing an embodiment.

Server 104, server 106, storage unit 108, client 110, client 112, client 114, device 122, request management engine 126 may couple to network 102 using wired connections, wireless communication protocols, or other suitable data connectivity. Client 110, client 112 and client 114 may be, for example, personal computers or network computers.

In the depicted example, the servers may provide data, such as boot files, operating system images, and applications to client 110, client 112, and client 114. Client 110, client 112 and client 114 may be clients to servers in this example. Client 110, client 112 and client 114 or some combination thereof, may include their own data, boot files, operating system images, and applications. Data processing environment 100 may include additional servers, clients, and other devices that are not shown. Server 104, server 106, and/or request management engine 126 may include applications such as server application 116, or request management code 118 that may be configured to implement one or more of the functions described herein in accordance with one or more embodiments. Therefore, incoming operator requests 306 can be managed based on impact assessment predictions and a skill of the operator. In some cases, the data processing environment 100 may be embodied as a Kubernetes-based cloud environment. Servers or nodes may comprise daemons or background processes running based on request management code 118 to manage incoming operator requests 306 and train the operator.

Device 122 is an example of a device described herein. For example, device 122 can take the form of a smartphone, a tablet computer, a laptop computer, client 110 in a stationary or a portable form, a wearable computing device, or any other suitable device. Any software application described as executing in another data processing system in FIG. 1 can be configured to execute in device 122 in a similar manner. Any data or information stored or produced in another data processing system in FIG. 1 can be configured to be stored or produced in device 122 in a similar manner. Database 120 of storage unit 108 may be or include stores one or more term change histories and word frequency histories stored in repositories for computations herein.

The data processing environment 100 may also be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service-oriented architecture where interoperable software components distributed across a network may be packaged together as coherent business applications. Data processing environment 100 may also take the form of a cloud and employ a cloud computing model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 200 contains an example of an environment for the execution of at least some of the computer code involved in performing the inventive methods, such as request management code 118. In addition to request management code 118, computing environment 200 includes, for example, computer 202, wide area network 228 (WAN), end user device 230 (EUD), remote server 232, public cloud 240, and private cloud 236. In this embodiment, computer 202 includes processor set 204 (including processing circuitry 206 and cache 208), communication fabric 210, volatile memory 212, persistent storage 214(including operating system 216 and request management code 118, as identified above), peripheral device set 218 (including user interface (UI) device set 220, storage 222, and Internet of Things (IoT) sensor set 224), and network module 226. Remote server 232 includes remote database 234. Public cloud 240 includes gateway 238, cloud orchestration module 242, host physical machine set 246, virtual machine set 244, and container set 248.

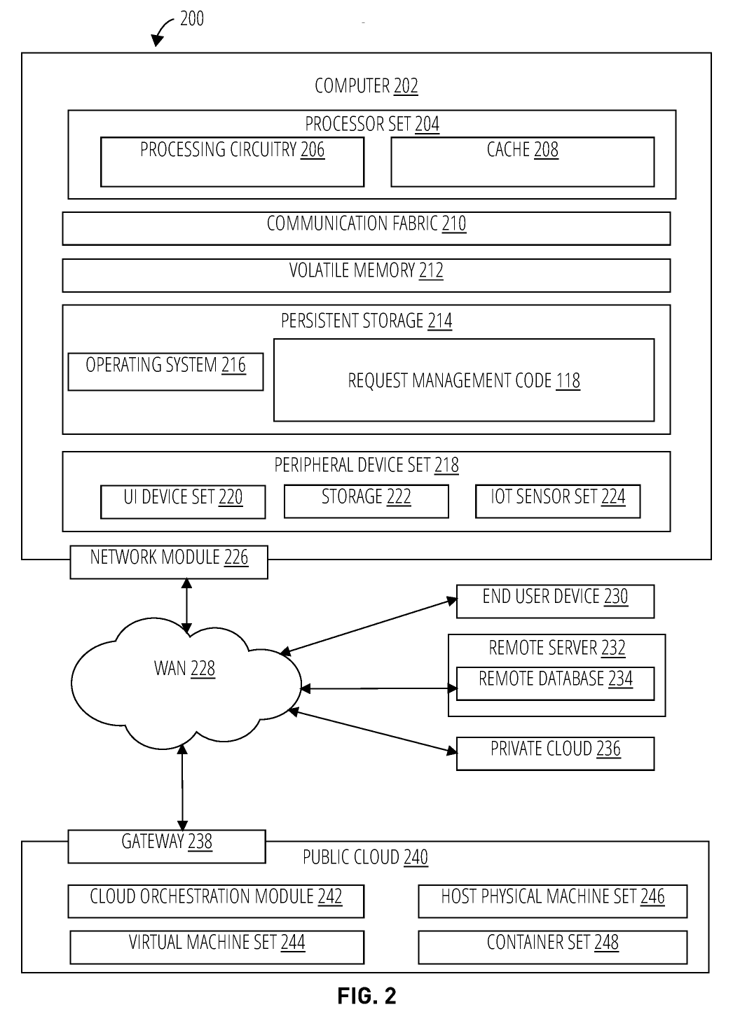

Computer 202 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 234. As is well understood in the art of computer technology, and depending upon the technology, performance of a computer-implemented method may be distributed among multiple computers and/or between multiple locations. On the other hand, in this presentation of computing environment 200, detailed discussion is focused on a single computer, specifically computer 202, to keep the presentation as simple as possible. Computer 202 may be located in a cloud, even though it is not shown in a cloud in FIG. 2. On the other hand, computer 202 is not required to be in a cloud except to any extent as may be affirmatively indicated.

Processor set 204 includes one, or more, computer processors of any type now known or to be developed in the future. Processing circuitry 206 may be distributed over multiple packages, for example, multiple, coordinated integrated circuit chips. Processing circuitry 206 may implement multiple processor threads and/or multiple processor cores. Cache 208 is memory that is located in the processor chip package(s) and is typically used for data or code that should be available for rapid access by the threads or cores running on processor set 204. Cache memories are typically organized into multiple levels depending upon relative proximity to the processing circuitry. Alternatively, some, or all, of the cache for the processor set may be located “off chip.” In some computing environments, processor set 204 may be designed for working with qubits and performing quantum computing.

Computer readable program instructions are typically loaded onto computer 202 to cause a series of operational steps to be performed by processor set 204 of computer 202 and thereby effect a computer- implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 208 and the other storage media discussed below. The program instructions, and associated data, are accessed by processor set 204 to control and direct performance of the inventive methods. In computing environment 200, at least some of the instructions for performing the inventive methods may be stored in request management code 118 in persistent storage 214.

Communication fabric 210 is the signal conduction path that allows the various components of computer 202 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

Volatile memory 212 is any type of volatile memory now known or to be developed in the future. Examples include dynamic type random access memory (RAM) or static type RAM. Typically, volatile memory 212 is characterized by random access, but this is not required unless affirmatively indicated. In computer 202, the volatile memory 212 is located in a single package and is internal to computer 202, but, alternatively or additionally, the volatile memory may be distributed over multiple packages and/or located externally with respect to computer 202.

Persistent storage 214 is any form of non-volatile storage for computers that is now known or to be developed in the future. The non-volatility of this storage means that the stored data is maintained regardless of whether power is being supplied to computer 202 and/or directly to persistent storage 214. Persistent storage 214may be a read only memory (ROM), but typically at least a portion of the persistent storage allows writing of data, deletion of data and re-writing of data. Some familiar forms of persistent storage include magnetic disks and solid-state storage devices. Operating system 216 may take several forms, such as various known proprietary operating systems or open-source Portable Operating System Interface-type operating systems that employ a kernel. The code included in request management code 118 typically includes at least some of the computer code involved in performing the inventive methods.

Peripheral device set 218 includes the set of peripheral devices of computer 202. Data communication connections between the peripheral devices and the other components of computer 202 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 220 may include components such as a display screen, speaker, microphone, wearable devices (such as goggles and smart watches), keyboard, mouse, printer, touchpad, game controllers, and haptic devices. Storage 222 is external storage, such as an external hard drive, or insertable storage, such as an SD card. Storage 222 may be persistent and/or volatile. In some embodiments, storage 222 may take the form of a quantum computing storage device for storing data in the form of qubits. In embodiments where computer 202 is required to have a large amount of storage (for example, where computer 202 locally stores and manages a large database) then this storage may be provided by peripheral storage devices designed for storing very large amounts of data, such as a storage area network (SAN) that is shared by multiple, geographically distributed computers. IoT sensor set 224 is made up of sensors that can be used in Internet of Things applications. For example, one sensor may be a thermometer, and another sensor may be a motion detector.

Network module 226 is the collection of computer software, hardware, and firmware that allows computer 202 to communicate with other computers through WAN 228. Network module 226 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 226 are performed on the same physical hardware device. In other embodiments (for example, embodiments that utilize software-defined networking (SDN)), the control functions and the forwarding functions of network module 226 are performed on physically separate devices, such that the control functions manage several different network hardware devices. Computer readable program instructions for performing the inventive methods can typically be downloaded to computer 202 from an external computer or external storage device through a network adapter card or network interface included in network module 226.

WAN 228 is any wide area network (for example, the internet) capable of communicating computer data over non-local distances by any technology for communicating computer data, now known or to be developed in the future. In some embodiments, the WAN 228 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User device 230 is any computer system that is used and controlled by an end user (for example, a customer of an enterprise that operates computer 202), and may take any of the forms discussed above in connection with computer 202. EUD 230 typically receives helpful and useful data from the operations of computer 202. For example, in a hypothetical case where computer 202 is designed to provide a recommendation to an end user, this recommendation would typically be communicated from network module 226 of computer 202 through WAN 228 to EUD 230. In this way, EUD 230 can display, or otherwise present, the recommendation to an end user. In some embodiments, EUD 230 may be a client device, such as thin client, heavy client, mainframe computer, desktop computer and so on.

Remote server 232 is any computer system that serves at least some data and/or functionality to computer 202. Remote server 232 may be controlled and used by the same entity that operates computer 202. Remote server 232 represents the machine(s) that collect and store helpful and useful data for use by other computers, such as computer 202. For example, in a hypothetical case where computer 202 is designed and programmed to provide a recommendation based on historical data, then this historical data may be provided to computer 202 from remote database 234 of remote server 232.

Public cloud 240 is any computer system available for use by multiple entities that provides on- demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 240 is performed by the computer hardware and/or software of cloud orchestration module 242. The computing resources provided by public cloud 240 are typically implemented by virtual computing environments that run on various computers making up the computers of host physical machine set 246, which is the universe of physical computers in and/or available to public cloud 240. The virtual computing environments (VCEs) typically take the form of virtual machines from virtual machine set 244 and/or containers from container set 248. It is understood that these VCEs may be stored as images and may be transferred among and between the various physical machine hosts, either as images or after instantiation of the VCE. Cloud orchestration module 242 manages the transfer and storage of images, deploys new instantiations of VCEs and manages active instantiations of VCE deployments. Gateway 238 is the collection of computer software, hardware, and firmware that allows public cloud 240 to communicate through WAN 228.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 236 is similar to public cloud 240, except that the computing resources are only available for use by a single enterprise. While private cloud 236 is depicted as being in communication with WAN 228, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 240 and private cloud 236 are both part of a larger hybrid cloud.

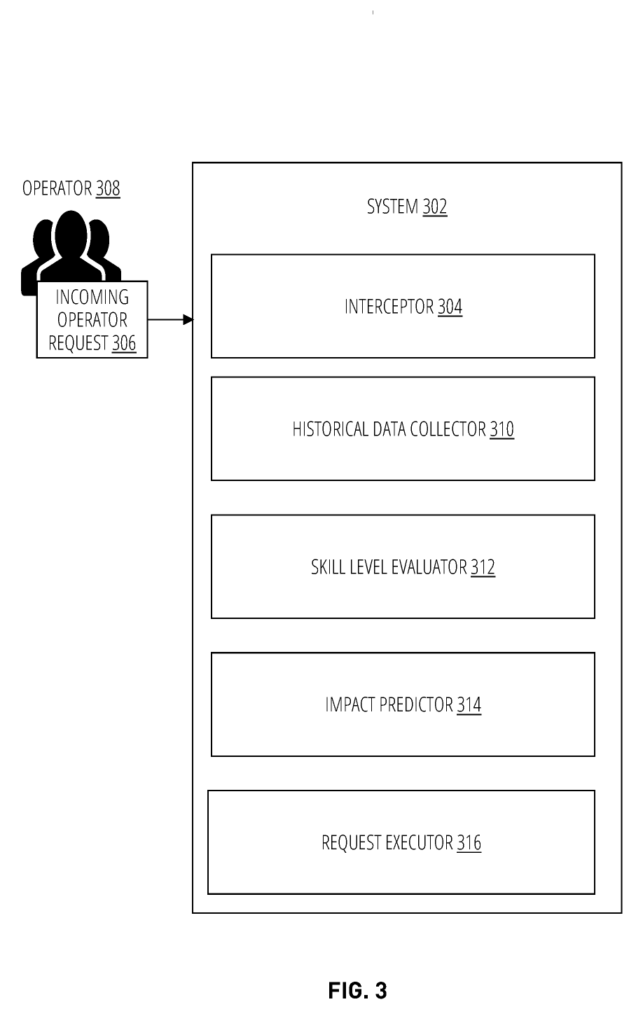

Reference is now made to FIG. 3 which illustrates a generalized system 302 in accordance with one or more embodiments. The system 302 may be operated based on request management code 118 to perform management of incoming operator requests as discussed herein. The system 302 is an example of request management engine 126 and comprises an interceptor 304, a historical data collector 310, a skill level evaluator 312, an impact predictor 314, and a request executor 316.

In an aspect herein, the interceptor 304 is authorized to intercept an incoming operator request 306 from an operator 308. The operator 308 may be an individual who is authenticated via an existing user-context which may be an authentication (e.g., VPN, or two-factor authentication) that is set up to provide operators access to the data processing environment 100 or a portion thereof. The interceptor 304 may be configured to listen for incoming operator requests 306 and to intercept all of such requests.

The historical data collector 310 collects information about historical actions of the operator 308 to obtain or compute a skill level of the operator 308. The skill level can be indicative of, for example, the operator's experience or the operator's understanding of the data processing environment 100. By learning from the operator's historical actions and outcomes of the historical actions, a skill level of the operator 308 may be generated with the skill level evaluator 312. Further, operator specific information such, as an intended outcome of future requests, and an amount of leeway reasonably applicable to the operator's request may be obtained based on the skill level.

The impact predictor 314 may be used to predict the potential impact of the incoming operator request 306 on the data processing environment 100 based on an understanding of how the data processing environment 100 works. In some embodiments, the understanding may be generated based on learning via machine learning/natural language processing about operations that can be performed on the data processing environment 100, how to operate the data processing environment 100, and corresponding results or potential impacts of the operations. In some cases, a corpus of operating instructions or guidance information may be available for interpreting to compute the outcome of the incoming operator commands. In other cases, a weighted algorithm or an algorithm of prioritization may be used to determine within a predetermined confidence level what outcomes are representative of the incoming operator requests 306. Based on the predicted potential impact and/or the skill level of the operator, the request executor 316 may block or execute the incoming operator request. A skill level of the user can also be updated (increased or decreased) accordingly.

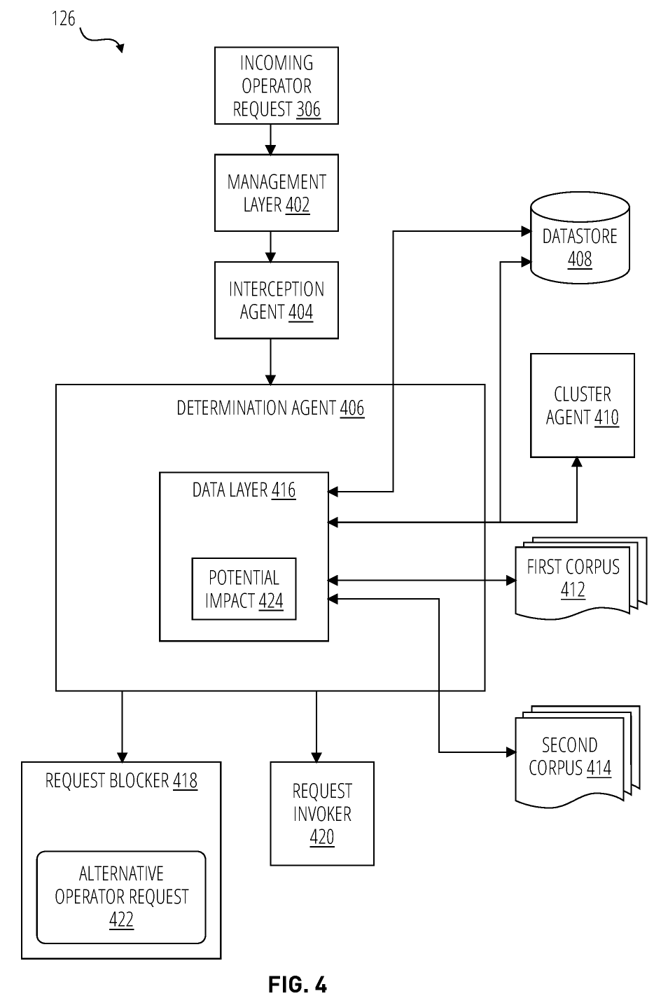

FIG. 4 illustrates a block diagram of a request management engine 126 in accordance with an illustrative embodiment. The request management engine 126 may be an example system 302 that runs in a distributed cloud environment, such as a Kubernetes-based cloud environment. According to an illustrative embodiment, the request management engine 126 identifies, and if appropriate, blocks the incoming operator requests 306 from being executed, based on knowledge of the environment. The knowledge can include dependencies, which show what resources are used by a plurality of services and how changing the resource can affect services. The knowledge can include configuration changes which show a change in the settings of one or more resources and consequences of the change. The knowledge can be obtained from learning about one or more of the historical input/output commands across the entire environment (for example, the aggregated historical actions or data of all users of the environment), outcomes of the commands, past incidents, documentation, and changelogs, illustrated in FIG. 4 as any of the first corpus 412 and the second corpus 414 to show that different sets of data may be accommodated.. A skill of the operator may additionally be used in blocking the execution of the incoming operator request 306. The request management engine 126 may be configured to study patterns and understand the outcome of intended actions to determine if execution of requests should be executed or blocked. The request management engine 126 assesses an individual operator’s knowledge based on the command history or interactions of the operator 308 with the environment and allows the operator 308 to learn new commands by providing feedback/suggestions when appropriate in real-time.

In the request management engine 126, the incoming operator request 306 may be intercepted by an interception agent 404 at a management layer 402 (access control layer) of the request management engine 126. The interceptor 304 may therefore be a part of the control plane of the cloud-based environment.

The request management engine 126 comprises a determination agent 406, a cluster agent 410, and a datastore 408. The datastore 408 can store information mapping operators 308 to their skill level which can be a model built to understand the skills and be increased or be decreased. The skill of an operator may in some embodiments be computed or modeled to be relative to other skill levels of other operators. The datastore 408 can also store records of historical incidents based on originating requests and their outcomes. Other information that can be used in determining a potential impact 424 of executing incoming operator requests 306 can also be stored on the datastore 408.

Upon intercepting an incoming operator request 306, the interception agent 404 requests from the determination agent 406 an evaluation of the incoming operator request 306. The determination agent 406 may work together with or control the cluster agent 410 to generate a prediction of the potential impact 424 of the incoming operator request 306. The cluster agent 410 monitors applications or workloads running on a cluster. The monitoring may be performed in real time. Upon receiving the evaluation request from the interception agent 404, the determination agent 406 may query the incoming operator request 306 against any corpora (e.g., first corpus 412, second corpus 414) of information about how to operate the environment.

In an example, the determination agent 406 queries the incoming operator request 306 against a history of incidents to compute a determination of outcomes for executing a request that matches the incoming operator request 306. The determination agent 406 further computes in conjunction with the cluster agent 410 components of the data processing environment 100 that will be affected and/or impacted by execution of the incoming operator request 306. The determination agent 406 further queries documentation, community change logs and internal product change logs to compute a determination of outcomes for executing the incoming operator request 306. The computed results are aggregated responsive to which the determination agent 406 predicts a potential impact 424. A data layer 416 of the environment may be used in the computations described herein.

Responsive to predicting the potential impact 424, the determination agent 406 can perform a risk analysis of allowing an execution of the incoming operator request 306 based on the predicted potential impact and/or the skill level of the operator. Upon determining in the risk analysis that execution of the incoming operator request 306 is not recommended (e.g., does not pass a predetermined risk threshold), a request blocker 418 may block execution of the incoming operator request 306 and generate feedback for the operator 308. The feedback can include an alternative operator request 422 which may be determined be the originally intended request of the operator based on contextual analysis of the initial request and the history of requests from the operator 308. Upon determining in the risk analysis that the execution of the incoming operator request 306 is recommended (e.g., passes the predetermined risk threshold) the request invoker 420 executes or allows the execution of the incoming operator request 306.

In some embodiments, a feedback loop may be established to update the datastore 408, first corpus 412 and second corpus 414 with information obtained from the interaction of the operator 308 with the environment. In addition to updating the skill level of the operator, an analysis of the growth of the operator may also be performed and used in updating the skill level.

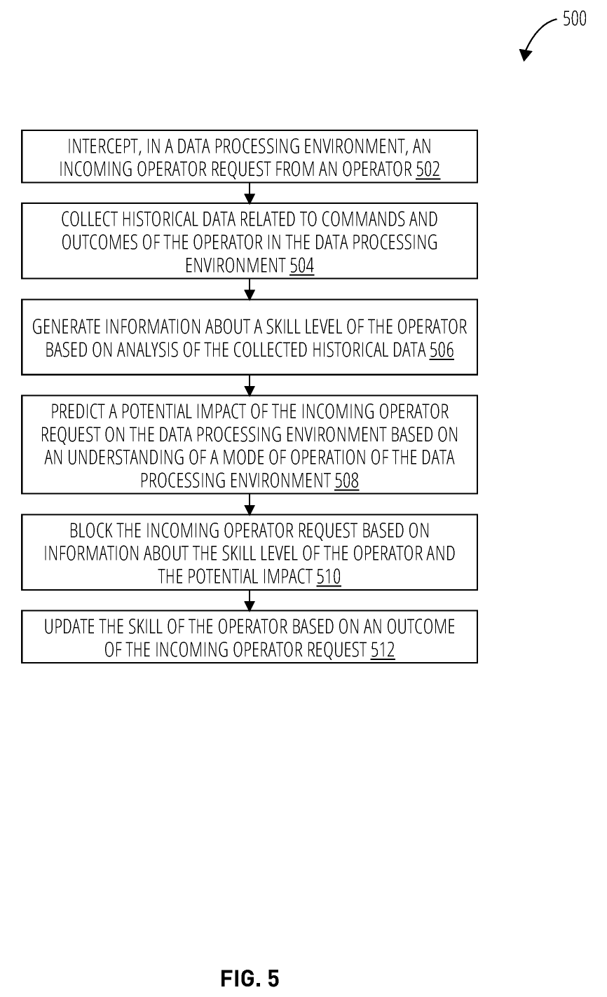

FIG. 5 illustrates a routine 500 for managing operator requests in accordance with an illustrative embodiment. The routine 500 may be performed with the request management engine 126. In block 502, the request management engine 126 intercepts in a data processing environment 100 an incoming operator request from an operator 308. The data processing environment 100 can be a cloud-based environment and the request management engine 126 may be disposed on each server of the cloud-based environment. In block 504, the request management engine 126 collects historical data related to commands and outcomes of the operator 308 in the data processing environment 100. In block 506, the request management engine 126 generates information about a skill level of the operator 308 based on analysis of the collected historical data. In block 508, the request management engine 126 predicts a potential impact of the incoming operator request on the data processing environment based on an understanding of a mode of operation of the data processing environment. In block 510, the request management engine 126 blocks the incoming operator request based on information about the skill level of the operator 308 and the potential impact. In block 512, routine 500 updates the skill of the operator based on an outcome of the incoming operator request.

In a specific example, an operator 308 may request a change to a container image for a database. The change has the characteristic of updating the database from a first version to a second version. The cluster agent 410 determines that the first version is currently installed. The determination agent 406 generates an understanding that the request will install the second version. The determination agent 406 thus, queries the first corpus 412 and second corpus 414 to determine results for when the request is executed. The determination agent 406 also queries the cluster agent 410 to determine if a current state of the environment will be impacted. The cluster agent 410 performs a check and determines that the current database configuration specifies a value that is unsupported in the second version. The determination agent 406 determines that the operator 308 of the unsupported value will cause incompatibility issues. The determination agent 406 determines that the operator 308 is interacting with the database for the first time, blocks the execution of the request and provides feedback to the operator 308.

In another specific example, an operator 308 request to scale down a database. Execution of the request will make the database inaccessible in a cluster. The determination agent queries sources of the determination agent 406 to determine a potential impact. Upon determining that a scale down of the database has been performed a plurality of times in the past, and the user has experience performing the action, the request is allowed.

### Conclusion

The descriptions of the various embodiments of the present teachings have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

The components, steps, features, objects, benefits and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Aspects of the present disclosure are described herein with reference to a flowchart illustration and/or block diagram of a method, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures herein illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A method of managing operator requests, comprising:
intercepting, in a data processing environment, an incoming operator request from an operator;
retrieving historical data related to commands and command outcomes of the operator in the data processing environment;
characterizing a skill level of the operator based on analysis of the retrieved historical data;
predicting a potential impact of the incoming operator request on the data processing environment based on an understanding of a mode of operation of the data processing environment;
blocking an execution of the incoming operator request based on information about the skill level of the operator and the potential impact; and
updating a characterization of the skill level of the operator based on an outcome of the incoming operator request.

2. The method of claim 1 further comprising assessing the incoming operator request for the prediction of the potential impact based on factors including dependencies and configuration changes of the data processing environment.

3. The method of claim 1, further comprising generating the understanding of the mode of operation of the data processing environment using a trained machine learning model.

4. The method of claim 3, further comprising generating the understanding of the mode of operation of the data processing environment through interpreting one or more of corpora including documentation, changelogs, past incidents, and aggregated historical actions of the data processing environment.

5. The method of claim 1, further comprising providing to the operator, responsive to the blocking, real-time feedback about alternative operator requests that meet a positive impact criterion.

6. The method of claim 1, further comprising updating a state of the data processing environment to reflect changes of the data processing environment in real time.

7. The method of claim 1, wherein the data processing environment is a Kubernetes-based cloud environment.

8. The method of claim 1, further comprising tracking an identity of the operator based on authenticating the operator.

9. A computing device comprising:
a processor; and
a memory, in communication with the processor, with one or more computer program instructions stored on the memory, the computer program instructions, when executed by the processor, cause the computing device to perform operations comprising:
intercepting, in a data processing environment, an incoming operator request from an operator;
retrieving historical data related to commands and command outcomes of the operator in the data processing environment;
characterizing a skill level of the operator based on analysis of the retrieved historical data;
predicting a potential impact of the incoming operator request on the data processing environment based on an understanding of a mode of operation of the data processing environment;
blocking an execution of the incoming operator request based on information about the skill level of the operator and the potential impact; and
updating a characterization of the skill level of the operator based on an outcome of the incoming operator request.

10. The computing device of claim 9, wherein the execution of the program instructions by the processor further configures the computing device to perform operations comprising:
assessing the incoming operator request for prediction of the potential impact based on factors including dependencies and configuration changes of the data processing environment.

11. The computing device of claim 9, wherein the execution of the program instructions by the processor further configures the computing device to perform operations comprising:
generating the understanding of the mode of operation of the data processing environment using a trained machine learning model.

12. The computing device of claim 11, wherein the execution of the program instructions by the processor further configures the computing device to perform operations comprising:
generating the understanding of the mode of operation of the data processing environment through interpreting one or more of corpora including documentation, changelogs, past incidents, and aggregated historical actions of the data processing environment.

13. The computing device of claim 11, wherein the execution of the program instructions by the processor further configures the computing device to perform operations comprising:
providing to the operator, responsive to the blocking, real-time feedback about alternative operator requests that meet a positive impact criterion.

14. The computing device of claim 11, wherein the execution of the program instructions by the processor further configures the computing device to perform operations comprising:
updating a state of the data processing environment to reflect changes of the data processing environment in real time.

15. The computing device of claim 11, wherein the data processing environment is a Kubernetes-based cloud environment.

16. The computing device of claim 11, wherein the execution of the program instructions by the processor further configures the computing device to perform operations comprising:
tracking an identity of the operator based on authenticating the operator.

17. A computer program product for managing operator requests, the computer program product comprising:
one or more computer-readable storage devices and program instructions stored on the at least one of the one or more computer-readable storage devices, the program instructions executable by a processor, the program instructions comprising:
program instructions to intercept, in a data processing environment, an incoming operator request from an operator;
program instructions to retrieve historical data related to commands and command outcomes of the operator in the data processing environment;
program instructions to characterize a skill level of the operator based on analysis of the retrieved historical data;
program instructions to predict a potential impact of the incoming operator request on the data processing environment based on an understanding of a mode of operation of the data processing environment;
program instructions to block an execution of the incoming operator request based on information about the skill level of the operator and the potential impact; and
program instructions to update a characterization of the skill level of the operator based on an outcome of the incoming operator request.

18. The computer program product of claim 17, wherein the program instructions further comprise:
program instructions to assess the incoming operator request for prediction of the potential impact based on factors including dependencies and configuration changes of the data processing environment.

19. The computer program product of claim 17, wherein the program instructions further comprise:
program instructions to provide to the operator, responsive to the blocking, real-time feedback about alternative operator requests that meet a positive impact criterion.

20. The computer program product of claim 17, wherein the program instructions further comprise:
program instructions to track an identity of the operator based on authenticating the operator.
